(19) United States
(12) Patent Application Publication
(10) Pub. No.: US 2016/0201631 A1
(43) Pub. Date: Jul. 14, 2016

(54) COMBUSTION CHAMBER STRUCTURE FOR ENGINE

(71) Applicant: Mazda Motor Corporation, Aki-gun (JP)

(72) Inventors: Takaaki Nagano, Higashihiroshima-shi (JP); Masahisa Yamakawa, Hiroshima-shi (JP); Takashi Youso, Hiroshima-shi (JP); Kazuhiro Nagatsu, Hiroshima-shi (JP); Tatsuya Fujikawa, Higashihiroshima-shi (JP); Wu Zhang, Higashihiroshima-shi (JP); Takashi Kaminaga, Hiroshima-shi (JP); Toru Miyamoto, Higashihiroshima-shi (JP); Shintaro Okada, Aki-gun (JP); Yuki Hisadome, Hatsukaichi-shi (JP)

(21) Appl. No.: 14/979,364

(22) Filed: Dec. 22, 2015

(30) Foreign Application Priority Data
Jan. 9, 2015 (JP) 2015-003374

(51) Int. Cl. F02M 61/14; F02F 3/28

(52) U.S. Cl. CPC F02M 61/14; F02F 3/28

(57) ABSTRACT

A combustion chamber structure for an engine is provided. The combustion chamber structure includes a piston formed with a downward dented cavity at a central part of an upper surface thereof, and a fuel injector provided above the piston and on an extended line of a central axis of the piston, the fuel injector changing an injection timing of fuel on a compression stroke according to an operating state of the engine. A fuel injection angle of the fuel injector is designed to satisfy conditions in which the fuel is injected into the cavity and in which a fuel spray collision distance defined from a fuel injection position of the fuel injector to a collision position of the fuel with the cavity is longer than a breakup length defined from the fuel injection position of the fuel injector to a position where an initial breakup of the fuel occurs.

### BACKGROUND

The present invention relates to a combustion chamber structure for an engine, and particularly to a combustion chamber structure for an engine for injecting fuel on a compression stroke within a predetermined engine operating range.

Generally, for engines using gasoline or a fuel mainly containing gasoline, a spark-ignition method in which ignition is performed by an ignition plug is broadly adopted. Recently, in view of improving fuel consumption performance, arts for performing compression self-ignition (specifically, premixed compression self-ignition referred to as Homogeneous-Charge Compression Ignition (HCCI)) within a predetermined engine operating range while using gasoline or the fuel mainly containing gasoline by applying a high compression ratio (e.g., 17:1 or higher) as a geometric compression ratio of the engine are developed.

One art regarding an engine which performs such a compression self-ignition is disclosed in JP2012-172662A, for example. In the art of JP2012-172662A, the engine performs the compression self-ignition within a low engine load range and performs spark ignition within a high engine load range, and within the high engine load range, the fuel is injected into a cavity of a piston of the engine and mixture gas containing the fuel is ignited at a timing at which the mixture gas reaches the vicinity of an ignition plug of the engine.

In such an engine, within the high engine load range (specifically, a range where the engine speed is low and the engine load is high), the fuel is injected on a compression stroke, specifically, the fuel is injected by setting a fuel injection start timing to be on a retarded side (i.e., retarded injection). When injecting the fuel near a top dead center on the compression stroke in such an engine, since the piston is quite close to a fuel injector of the engine, the fuel injector has a wide range of injection angles within which the fuel can be injected into the cavity. Thus, the fuel can suitably be injected into the cavity without strictly designing the injection angle of the fuel injector. However, when injecting the fuel at an early timing on the compression stroke (i.e., an advanced degree of the injection timing on the compression stroke is large), since the piston is comparatively far from the fuel injector, the range of the injection angle within which the fuel can be injected into the cavity becomes narrower. Thus, it becomes difficult to suitably inject the fuel into the cavity. Therefore, to suitably inject the fuel into the cavity even at the early timing on the compression stroke, it can be said that the designing of the injection angle needs to be strict.

Here, if the fuel is not injected into the cavity but to a cylinder wall (e.g., cylinder liner), the fuel may adhere to the wall and not be combusted (i.e., causing insufficient combustion), or the fuel adhered to the cylinder wall may be scraped out of the cylinder by a piston ring and mixed with engine oil, causing oil dilution. Further, even when the fuel is not injected to the cylinder wall, if the fuel is injected to a portion of an upper surface of the piston outward of the cavity, the fuel moves outward of the upper surface in radial directions of the piston and adheres to the cylinder wall, which may lead to issues similar to those described above. In this regard, by injecting the fuel into the cavity, the fuel remains within the cavity and, thus, the movement of the fuel to the cylinder wall can be suppressed.

Meanwhile, it is known that the fuel injected by the fuel injector generates an initial breakup and is atomized once it travels a certain distance. When the fuel injected by the fuel injector collides with a wall surface of a combustion chamber (e.g., the upper surface of the piston), if the fuel is in a state after the initial breakup, it can be considered that the vaporizability of the fuel improves and combustion stability also improves compared to a case where the fuel injected by the fuel injector collides with the wall surface of the combustion chamber before the initial breakup. Therefore, it can be said to be preferable to configure the engine for injecting the fuel into the cavity as described above, such that the fuel in the state after the initial breakup collides with a surface of the cavity.

### SUMMARY

The present invention is made in view of solving the issues of the conventional art described above, and aims to provide a combustion chamber structure for an engine, in which fuel can surely be injected into a cavity by injecting the fuel at a suitable injection angle and the fuel can collide with a surface of the cavity at a distance longer than a breakup length.

According to one aspect of the present invention, a combustion chamber structure for an engine is provided. The engine injects fuel on a compression stroke within a predetermined engine operating range. The combustion chamber structure includes a piston formed with a downward dented cavity at a central part of an upper surface thereof, and a fuel injector provided above the piston and on an extended line of a central axis of the piston, the fuel injector changing an injection timing of the fuel on the compression stroke according to an operating state of the engine. A fuel injection angle of the fuel injector is designed to satisfy both of a first condition in which the fuel is injected into the cavity of the piston and a second condition in which a fuel spray collision distance is longer than a breakup length, the fuel spray collision distance defined from a fuel injection position of the fuel injector to a position of the cavity of the piston with which the fuel collides, the breakup length defined from the fuel injection position of the fuel injector to a position where initial breakup of the fuel occurs.

With this configuration, by suitably designing the injection angle of the fuel injector, the fuel spray collision distance can be longer than the breakup length and the fuel can surely be injected into the cavity of the piston at any of the injection timings of the fuel on the compression stroke. Therefore, by surely injecting the fuel into the cavity of the piston, adhesion of the fuel to a cylinder wall can be suppressed. Further, by designing the fuel spray collision distance to be longer than the breakup length and causing the fuel to collide with a surface of the cavity, an adhesion amount of the fuel to the surface of the cavity can be reduced to improve vaporizability of the fuel, and combustion stability can be improved to suppress generation of smoke.

Preferably, the first condition is a condition in which when the fuel is injected by the fuel injector at an earliest timing on the compression stroke, the fuel is injected into the cavity of the piston.

With this configuration, based on the first condition defined by using the earliest timing of the fuel injection on the compression stroke, the fuel injection into the cavity of the piston can more effectively be achieved.

Preferably, when a radius of the cavity is “Rc,” a distance from a position of the upper surface of the piston to the fuel injector at an earliest timing of the fuel injection on the compression stroke is “Lp,” and the fuel injection angle of the fuel injector is “α,” the first condition is expressed by the following Equation 1:

Rc>Lp×tan α (1).

Preferably, the second condition is a condition in which the fuel spray collision distance is longer than the breakup length when the fuel is injected by the fuel injector at a top dead center on the compression stroke.

With this configuration, based on the second condition defined by using the compression top dead center, the fuel spray collision distance longer than the breakup length can more effectively be secured.

Preferably, when a depth of the cavity is “Dc,” a pressure of the fuel injected by the fuel injector is “Pf,” a pressure inside the combustion chamber is “Pa,” the fuel injection angle of the fuel injector is “α,” and a predetermined coefficient is “k,” the second condition is expressed by the following Equation 2:

Dc>k×Pa×cos α/{2(Pf−Pa)} (2).

### BRIEF DESCRIPTION OF THE DRAWINGS

FIG. 1 is a schematic top view of a single cylinder in a cylinder axis direction, the single cylinder applied with a combustion chamber structure for an engine according to one embodiment of the present invention.

FIG. 2 is a top view of a piston in the cylinder axis direction according to the embodiment of the present invention.

FIG. 3 is a partial cross-sectional view of FIG. 1 taken along a line in FIG. 1, including the piston and a cylinder head according to the embodiment of the present invention.

FIG. 4 is a chart regarding a breakup length of fuel and illustrating a relationship between a fuel spray collision distance and a vaporization amount increase ratio according to fuel pressure.

FIGS. 5A, 5B, and 5C are partial cross-sectional views of FIG. 1 taken similarly to FIG. 3 and including the piston and the cylinder head according to the embodiment of the present invention, illustrating collision positions of fuel when an injection angle is variously changed, respectively.

### DETAILED DESCRIPTION OF EMBODIMENT

Hereinafter, a combustion chamber structure for an engine according to one embodiment of the present invention is described with reference to the appended drawings.

Before describing the contents of this embodiment of the present invention, a conditional configuration of an engine in this embodiment is briefly described. The engine of this embodiment is operated at a high compression ratio, for example, a geometric compression ratio is 14:1 or higher (suitably, between 17:1 and 18:1). Within a predetermined operating range of the engine (e.g., a range where an engine speed is low and an engine load is high), the engine injects fuel on a compression stroke, specifically, injects the fuel by setting a retarded fuel injection start timing (retarded injection), and ignites the fuel after a top dead center of the compression stroke (CTDC). Further, the engine of this embodiment performs premixed compression self-ignition referred to as HCCI within a predetermined low engine load range.

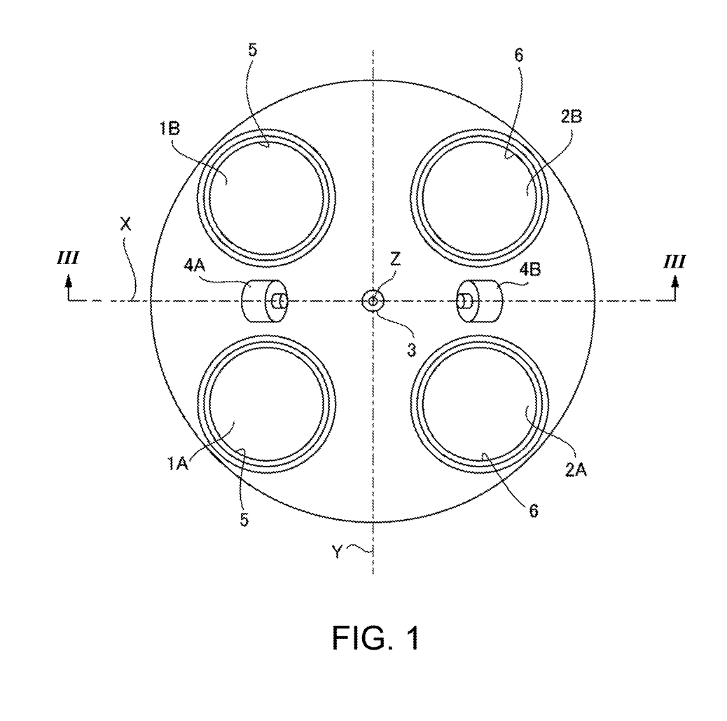

FIG. 1 is a schematic top view of a single cylinder in a cylinder axis direction, the single cylinder applied with the combustion chamber structure for the engine according to this embodiment of the present invention. In FIG. 1, the reference character “Z” indicates a central axis of the cylinder extending in a direction perpendicular to the drawing sheet (cylinder axis), and the reference character “Y” indicates a crankshaft axis extending in up-and-down directions of the drawing sheet. Further, the reference character “X” indicates a line segment passing through the cylinder axis and perpendicular to the crankshaft axis Y.

As illustrated in FIG. 1, the single cylinder is provided with two intake valves 1A and 1B at one side (left side in FIG. 1) section thereof with respect to the crankshaft axis Y. The two intake valves 1A and 1B are arranged in line along the crankshaft axis Y. The reference characters “5” in FIG. 1 indicate intake ports opened and closed by the intake valves 1A and 1B. Hereinafter, when describing the two intake valves 1A and 1B without differentiating them from each other, each of the two intake valves 1A and 1B may simply be referred to as “the intake valve 1.”

Further, the single cylinder is provided with two exhaust valves 2A and 2B at the other side (right side in FIG. 1) section thereof with respect to the crankshaft axis Y. The two exhaust valves 2A and 2B are arranged in line along the crankshaft axis Y. The reference characters “6” in FIG. 1 indicate exhaust ports opened and closed by the two exhaust valves 2A and 2B. Hereinafter, when describing the two exhaust valves 2A and 2B without differentiating them from each other, each of the two exhaust valves 2A and 2B may simply be referred to as “the exhaust valve 2.”

Moreover, a single fuel injector 3 is disposed in an extended line of the cylinder axis Z. Additionally, a first ignition plug 4A is disposed between the intake valves 1A and 1B, and a second ignition plug 4B is disposed between the exhaust valves 2A and 2B. Hereinafter, when describing the two first and second ignition plugs 4A and 4B without differentiating them from each other, each of the two first and second ignition plugs 4A and 4B may simply be referred to as “the ignition plug 4.”

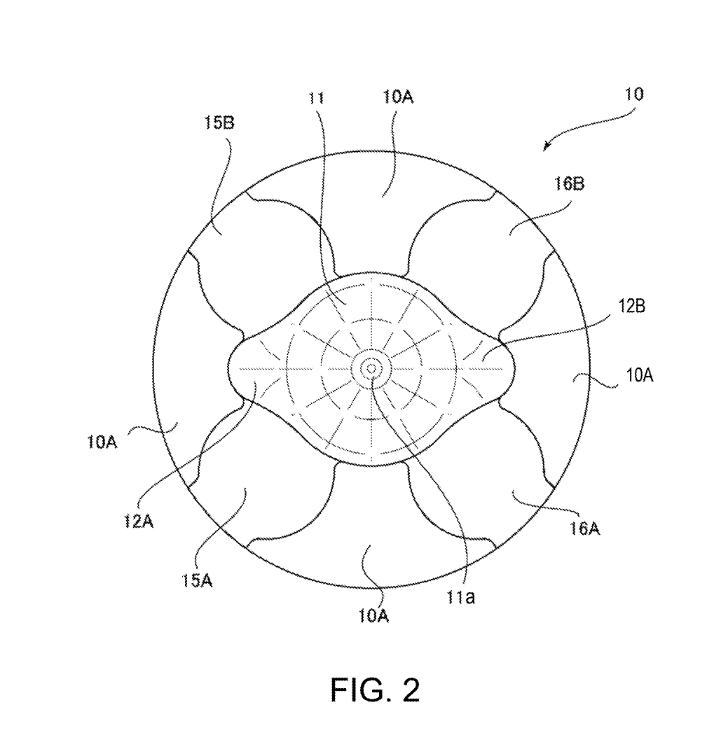

FIG. 2 is a top view of a piston 10 in the cylinder axis direction according to the embodiment of the present invention.

As illustrated in FIG. 2, a downward dented cavity 11 is formed at a central part of an upper surface (i.e., crown surface/top surface) of the piston 10. The cavity 11 has a circular shape when seen in the direction of the cylinder axis Z, and is formed with a bulge portion 11a at a central portion of the cavity 11. The cavity 11 is further formed with two concave portions 12A and 12B continuous from both side ends of the cavity 11, respectively. The fuel injector 3 is disposed immediately above the bulge portion 11a of the cavity 11, the first ignition plug 4A is disposed within the concave portion 12A of the cavity 11 when the piston is at the top dead center, and the second ignition plug 4B is disposed within the concave portion 12B of the cavity 11 when the piston is at the top dead center.

Moreover, the upper surface of the piston 10 is formed with four valve recesses 15A, 15B, 16A and 16B concaving downward by about 1 mm, for example. The valve recess 15A is formed at a position corresponding to the intake valve 1A, the valve recess 15B is formed at a position corresponding to the intake valve 1B, the valve recess 16A is formed at a position corresponding to the exhaust valve 2A, and the valve recess 16B is formed at a position corresponding to the exhaust valve 2B. Further, the upper surface of the piston 10, except for the cavity 11 and the valve recesses 15A, 15B, 16A and 16B, is substantially flat in directions perpendicular to the cylinder axis Z. In FIG. 2, each of the flat portions is denoted with the reference character “10A” (hereinafter, each flat portion is suitably described as “the piston upper surface portion 10A”).

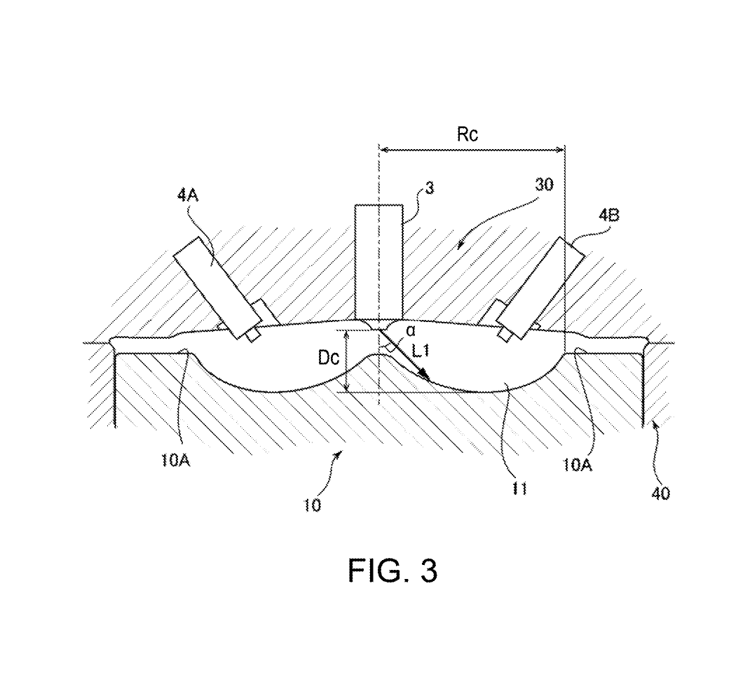

FIG. 3 is a partial cross-sectional view of FIG. 1 taken along a line in FIG. 1, including the piston 10 and a cylinder head 30 according to this embodiment of the present invention. Particularly, FIG. 3 illustrates a state when the piston 10 is at the CTDC. Further, regarding the fuel injector 3 and the ignition plugs 4, FIG. 3 illustrates side views instead of cross-sectional views. Note that in FIG. 3, for the sake of convenience, the illustration is mainly given for a rightward flow of mixture gas containing the fuel injected by the fuel injector 3. Practically, the fuel is sprayed outward in radial directions of the piston to spread symmetrically with respect to the cylinder axis direction, so that the fuel spreads uniformly inside the combustion chamber.

In FIG. 3, the reference character “Rc” indicates a radius of the cavity 11, the reference character “Dc” indicates a depth of the cavity 11 corresponding to a distance between the fuel injector 3 and a deepest portion of the cavity 11 in the cylinder axis direction when the piston 10 is at the top dead center (CTDC), and the reference character “a” indicates a fuel injection angle of the fuel injector 3, defined based on the cylinder axis (i.e., a central axis of the fuel injector 3). Further, the reference character “L1” indicates a distance from a fuel injection position of the fuel injector 3 to a position of the cavity 11 with which the fuel collides when the fuel is injected by the fuel injector 3 at the CTDC (fuel spray collision distance).

As illustrated in FIG. 3, in this embodiment, the fuel is injected by the fuel injector 3 toward the cavity 11, in other words, into the cavity 11. Further in this embodiment, the fuel spray collision distance L1 when the fuel is injected by the fuel injector 3 at the CTDC is designed to be longer than a length from the fuel injection position of the fuel injector 3 to a position where initial breakup of the fuel occurs (breakup length). Specifically, in this embodiment, the injection angle α of the fuel injector 3 is designed according to the cavity radius Rc, the cavity depth Dc, etc., so that the fuel is surely injected into the cavity 11 by the fuel injector 3 and the fuel spray collision distance L1 becomes longer than the breakup length.

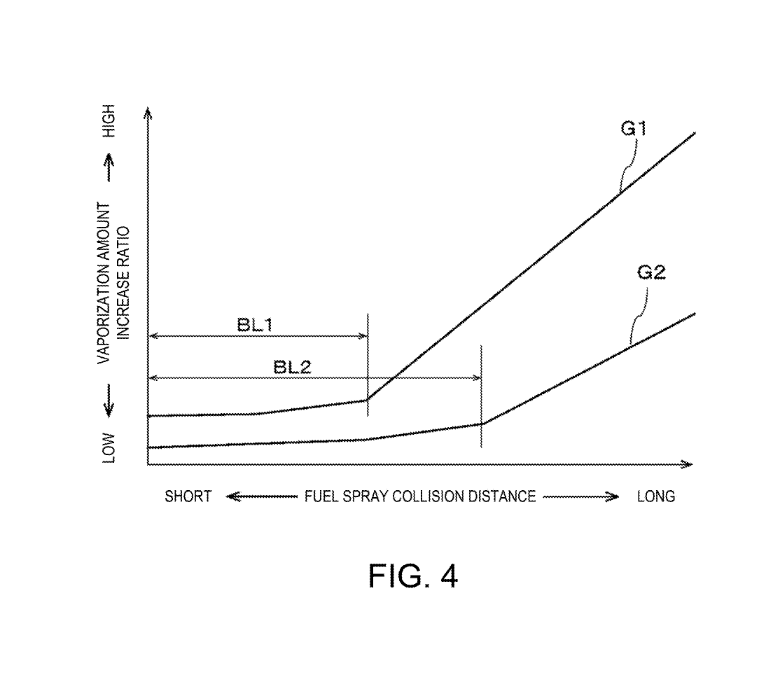

Here, the breakup length of the fuel is described in detail with reference to FIG. 4 in which the horizontal axis indicates the fuel spray collision distance by which the fuel injected by the fuel injector 3 travels to collide with a wall surface of the combustion chamber (e.g., the upper surface of the piston 10), and the vertical axis indicates a vaporization amount increase ratio corresponding to a vaporization amount of the injected fuel inside the combustion chamber. Basically, as the vaporization amount increase ratio becomes higher, the vaporization amount of the fuel becomes larger and the combustion stability improves. Further, the graph G1 indicates a relationship between the fuel spray collision distance and the vaporization amount increase ratio when a comparatively high fuel pressure (e.g., 120 MPa) is applied, and the graph G2 indicates a relationship between the fuel spray collision distance and the vaporization amount increase ratio when a fuel pressure lower than that of the graph G1 (e.g., 80 MPa) is applied. According to the graphs G1 and G2, it can be understood that the vaporization amount increase ratio is higher when the fuel pressure is high. Such a result is obtained because atomization of the fuel becomes easier as the fuel pressure becomes higher.

Moreover, according to the graph G1, it can be understood that when the fuel spray collision distance is below a distance BL1, the vaporization amount increase ratio is substantially constant regardless of the fuel spray collision distance, but when the fuel spray collision distance becomes equal to or longer than the distance BL1, the vaporization amount increase ratio becomes higher as the fuel spray collision distance becomes longer. Similarly, according to the graph G2, it can be understood that when the fuel spray collision distance is below a distance BL2, the vaporization amount increase ratio is substantially constant regardless of the fuel spray collision distance, but when the fuel spray collision distance becomes equal to or longer than the distance BL2, the vaporization amount increase ratio becomes higher as the fuel spray collision distance becomes longer.

Here, it is known that the fuel injected by the fuel injector 3 generates an initial breakup and is atomized once it travels a certain distance (i.e., breakup length). When the fuel after the initial breakup collides with the wall surface of the combustion chamber, it can be considered that the vaporizability of the fuel improves compared to a case where the fuel before the initial breakup collides with the wall surface of the combustion chamber. In other words, it can be considered that when the fuel collides with a position of the wall surface of the combustion chamber downstream of a position where the initial breakup occurs, the adhesion of the fuel to the wall surface is reduced compared to a case where the fuel collides with a position of the wall surface of the combustion chamber upstream of the position where the initial breakup occurs, and thus, the fuel vaporization amount increases. Therefore, each of the distances BL1 and BL2 at which the vaporization amount increase ratio starts to increase is considered to correspond to the breakup length at which the initial breakup of the fuel occurs. Further, since the atomization of the fuel spray becomes easier as the fuel pressure becomes higher, it can be considered that the breakup length is shorter with the comparatively high fuel pressure indicated by the graph G1 than with the comparatively low fuel pressure indicated by the graph G2.

Note that through an experiment or a simulation, a result was obtained, in which the breakup length when the fuel pressure of 120 MPa is applied (corresponding to the distance BL1) is about 15 mm, and the breakup length when the fuel pressure of 80 MPa is applied (corresponding to the distance BL2) is about 20 mm.

Returning to FIG. 3, the fuel spray collision distance L1 when the fuel is injected by the fuel injector 3 at the CTDC can be expressed by the following Equation 3 by using the cavity depth Dc and the injection angle α:

L1=Dc/cos α (3).

On the other hand, when the breakup length from the fuel injection position of the fuel injector 3 to the position where the initial breakup of the fuel occurs is “BL,” the breakup length BL can be expressed by the following Equation 4 by using “Pf” indicating the pressure of the fuel injected by the fuel injector 3, “Pa” indicating pressure inside the combustion chamber, and “k” indicating a predetermined coefficient:

BL=k×Pa/{2(Pf−Pa)} (4).

Equation 4 is derived based on the Bernoulli's principle, by using the experiment/simulation result in which the breakup length when the fuel pressure at 120 MPa is applied is about 15 mm, and the breakup length when the fuel pressure at 80 MPa is applied is about 20 mm. In this case, the pressure Pa inside the combustion chamber is 4 MPa, for example. Further, the predetermined coefficient k is a value determined based on a diameter of a nozzle hole of the fuel injector 3, etc., for example, between 0.8 and 0.9.

In this embodiment, as described above, the fuel spray collision distance L1 when the fuel is injected by the fuel injector 3 at the CTDC is designed to be longer than the breakup length BL, so that the fuel after the initial breakup collides with the surface of the cavity 11, in other words, with the position of the surface of the cavity 11 downstream of the position where the initial breakup occurs, and the adhesion amount of the fuel to the surface of the cavity 11 is reduced, thus the vaporizability of the fuel improves. Specifically, the injection angle α of the fuel injector 3 is designed based on the following Equation 5 applying Equations 3 and 4, so as to satisfy a condition “L1>BL”:

Dc>k×Pa×cos α/{2(Pf−Pa)} (5).

Note that as described above, by designing the fuel spray collision distance L1 when the fuel is injected at the CTDC to be longer than the breakup length BL, obviously, the fuel spray collision distance becomes longer than the breakup length BL even when the fuel is injected at a timing before the CTDC (i.e., a timing on the advanced side). Such a result is obtained because the position of the piston 10 before the CTDC is farther from the fuel injector 3 compared to the position of the piston 10 at the CTDC.

Further in this embodiment, although the injection timing of the fuel on the compression stroke is variously changed according to an operating state of the engine (e.g., an engine speed, an engine load, and an effective compression ratio, also including fuel pressure to be applied), the fuel is suitably injected into the cavity 11 of the piston 10 by applying any of the injection timings of the fuel on the compression stroke. Here, to satisfy the condition in which the fuel spray collision distance L1 described above is longer than the breakup length BL (second condition) described above, although the injection angle α of the fuel injector 3 may be increased (because the fuel spray collision distance L1 becomes longer as the injection angle α is increased), the fuel cannot suitably be injected into the cavity 11 if the injection angle α is excessively increased. Particularly, when the fuel is injected at an early timing on the compression stroke (i.e., an advanced degree of the injection timing on the compression stroke is large), since the piston 10 is comparatively far from the fuel injector 3, if the injection angle α is large, the fuel cannot suitably be injected into the cavity 11. To suitably inject the fuel into the cavity 11 in such a case, it is desirable to reduce the injection angle α of the fuel injector 3. Therefore, in this embodiment, the injection angle α of the fuel injector 3 is designed to satisfy both of a condition in which the fuel is suitably injected into the cavity 11 of the piston 10 (first condition) at any of the injection timings of the fuel on the compression stroke, and another condition in which the fuel spray collision distance L1 is longer than the breakup length BL (second condition).

Specifically, in this embodiment, the injection angle α of the fuel injector 3 is designed by having the second condition as a condition in which the fuel is suitably injected into the cavity 11 of the piston 10 when the fuel is injected at an earliest timing on the compression stroke (i.e., when a most advanced degree of the injection timing on the compression stroke is applied). At timings on the compression stroke other than the earliest timing, since the piston 10 is close to the fuel injector 3 compared to the earliest timing, by designing the injection angle α as above, the fuel is obviously suitably injected into the cavity 11.

Note that in view of suppressing pre-ignition in which the mixture gas self-ignites before a normal combustion start timing that is caused by a spark ignition, the earliest timing of the fuel injection on the compression stroke is defined based on the engine speed, the engine load, the effective compression ratio, the fuel pressure, etc.

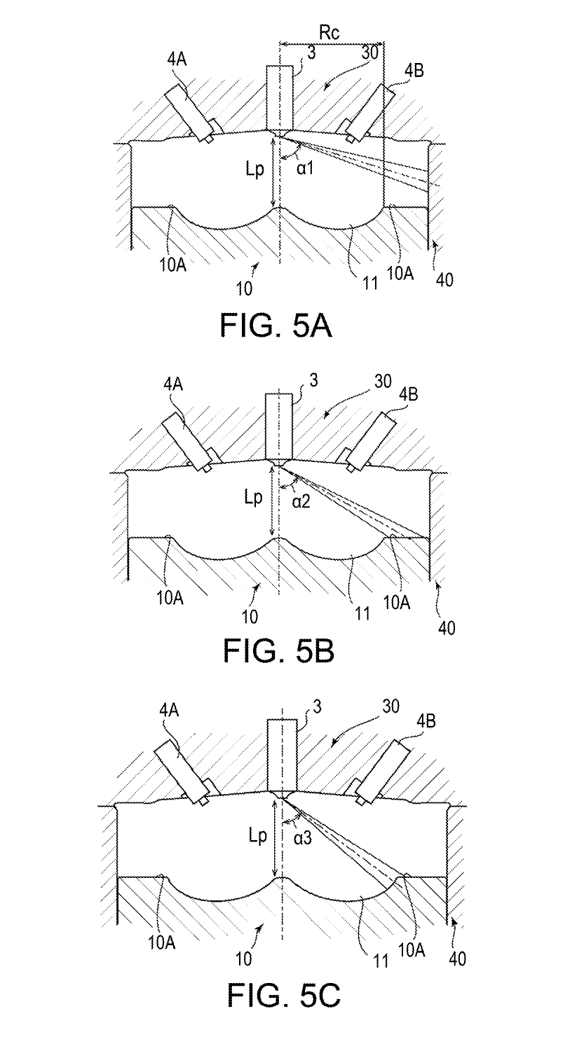

With reference to FIGS. 5A, 5B, and 5C, a method of designing the injection angle α of the fuel injector 3 to suitably inject the fuel into the cavity 11 is described in detail.

FIGS. 5A, 5B, and 5C show specific examples of the collision position of the fuel when the injection angle α of the fuel injector 3 is variously changed, respectively. FIGS. 5A, 5B, and 5C are partial cross-sectional views taken along the line in FIG. 1 similarly to FIG. 3 and including the piston 10 and the cylinder head 30 according to the embodiment of the present invention. FIGS. 5A, 5B, and 5C particularly illustrate the position of the piston 10 at the earliest timing of the fuel injection on the compression stroke (when the most advanced degree of the injection timing on the compression stroke is applied, for example, 45° before the top dead center (BTDC)). In this case, the reference character “Lp” in each of FIGS. 5A, 5B, and 5C indicates the distance between the position of the upper surface of the piston 10 at the earliest timing of the fuel injection on the compression stroke and the position of the fuel injector 3 in the cylinder axis direction. Further regarding the fuel injector 3 and the ignition plugs 4, FIGS. 5A, 5B, and 5C illustrate side views instead of cross-sectional views. Note that in FIGS. 5A, 5B, and 5C, for the sake of convenience, the illustration is mainly given for the rightward flow of the mixture gas containing the fuel injected by the fuel injector 3.

FIG. 5A illustrates a case where the fuel is injected at a comparatively large injection angle α1. It can be understood that in this case, the fuel collides with a cylinder liner 40 (a member for slidably contacting with a side surface of the piston 10). When the fuel collides with the cylinder liner 40, in other words, when a so-called “wet liner” state occurs, the fuel may adhere to the cylinder liner 40 and not be combusted, or the fuel adhered to the cylinder liner 40 may be scraped out of the cylinder by a piston ring and mixed with engine oil, causing oil dilution.

FIG. 5B illustrates a case where the fuel is injected at an injection angle α2 smaller than the injection angle α1 in FIG. 5A. It can be understood that in this case, the fuel collides, not with the cylinder liner 40, but with the piston upper surface portion 10A radially outward of the cavity 11. Also when the fuel collides with the piston upper surface portion 10A, the fuel moves outward in the radial directions of the piston and adheres to the cylinder liner 40, and thus, the “wet liner” state described above may occur.

FIG. 5C illustrates a case where the fuel is injected at an injection angle α3 even smaller than the injection angle α2 in FIG. 5B. It can be understood that in this case, the fuel is suitably injected into the cavity 11 of the piston 10. When the fuel is injected into the cavity 11, the fuel remains within the cavity 11, and the movement of the fuel to the cylinder liner 40 can be suppressed, in other words, the occurrence of the wet liner state described above can be suppressed. Thus, the fuel injected into the cavity 11 remains within the cavity 11 while gradually being vaporized, and flows upward.

In this embodiment, in view of suppressing the wet liner state, the injection angle α3 in FIG. 5C is adopted so that the fuel is suitably injected into the cavity 11 at any of the injection timings of the fuel on the compression stroke. Here, the injection angle α at which the fuel can suitably be injected into the cavity 11 at the earliest timing of the fuel injection on the compression stroke can be expressed in a generalized manner as follows.

To suitably inject the fuel into the cavity 11 at the earliest timing on the compression stroke, a distance from an intersecting position of a straight line corresponding to the injection angle α of the fuel injector 3 and a plane extending in the upper surface of the piston 10, to a central point of the upper surface of the piston 10 (hereinafter, referred to as “the distance L2”) may be designed to be smaller than the cavity radius Rc, in other words, “Rc>L2” may be satisfied. Note that the straight line corresponding to the injection angle α of the fuel injector 3 is taken cross-sectionally, in other words, it corresponds to a fuel injection direction. Further, the plane extending in the upper surface of the piston 10 includes, not only the upper surface of the piston 10, but also a plane extending from the upper surface of the piston 10. The distance L2 can be expressed by the following Equation 6 by using the distance Lp between the position of the upper surface of the piston 10 and the position of the fuel injector 3 at the earliest timing of the fuel injection on the compression stroke as illustrated in FIGS. 5A, 5B, and 5C:

L2=Lp×tan α (6).

Therefore, based on Equation 6, to suitably inject the fuel into the cavity 11 at the earliest timing on the compression stroke, the injection angle α of the fuel injector 3 may be designed to satisfy the following Equation 7:

Rc>Lp×tan α (7).

To sum up, in this embodiment, the injection angle α of the fuel injector 3 is designed to meet both of Equations 5 and 7 described above so that the second condition in which the fuel spray collision distance L1 is longer than the breakup length BL and the first condition in which the fuel is suitably injected into the cavity 11 of the piston 10 are satisfied at any of the injection timings of the fuel on the compression stroke.

Note that when a length of a connecting rod of the piston is “c” and a radius of a crankshaft is “r” (r indicates half of a stroke length of the piston), a distance x from a central axis of the crankshaft to the piston 10 at a certain crank angle θ is expressed by the following Equation 8:

x=r cos θ+{c²−(r sin θ)²}^{1/2} (8).

Therefore, when a crank angle corresponding to the earliest timing of the fuel injection on the compression stroke is “θ1,” the distance Lp described above can be expressed by the following Equation 9 based on Equation 8:

Lp=r(1−cos θ1)+c−{c²−(r sin θ1)²}^{1/2} (9).

In this example, the distance x from the central axis of the crankshaft to the piston 10 is used; however, the stroke length may alternatively be used. In this case, when the stroke length is “S,” and the radius r of the crankshaft and the connecting rod length c are expressed with “p” to be “p=r/c,” the stroke length S can be expressed by the following Equation 10:

S=r{(1−cos θ)+ρ/4(1−cos 2θ)} (10).

The distance Lp may be defined by using Equation 10.

Next, the operations and effects of the combustion chamber structure for the engine according to this embodiment of the present invention are described. According to this embodiment, by suitably designing the injection angle α of the fuel injector 3, the fuel spray collision distance L1 can be longer than the breakup length BL and the fuel can surely be injected into the cavity 11 of the piston 10 at any of the injection timings of the fuel on the compression stroke. Therefore, by surely injecting the fuel into the cavity 11 of the piston 10, the wet liner state in which the fuel adheres to the cylinder liner 40 can be suppressed. Further, by designing the fuel spray collision distance L1 to be longer than the breakup length BL, the adhesion amount of the fuel to the surface of the cavity 11 can be reduced to improve the vaporizability of the fuel, and the combustion stability can be improved to suppress generation of smoke.

It should be understood that the embodiments herein are illustrative and not restrictive, since the scope of the invention is defined by the appended claims rather than by the description preceding them, and all changes that fall within metes and bounds of the claims, or equivalence of such metes and bounds thereof, are therefore intended to be embraced by the claims.

### LIST OF REFERENCE CHARACTERS

1A, 1B Intake Valve
2A, 2B Exhaust Valve
Fuel Injector
4A First Ignition Plug
4B Second Ignition Plug
10 Piston
11 Cavity
30 Cylinder Head
40 Cylinder Liner

What is claimed is:

1. A combustion chamber structure for an engine, the engine injecting fuel on a compression stroke within a predetermined engine operating range, the combustion chamber structure comprising:
a piston formed with a downward dented cavity at a central part of an upper surface thereof; and
a fuel injector provided above the piston and on an extended line of a central axis of the piston, the fuel injector changing an injection timing of the fuel on the compression stroke according to an operating state of the engine,
wherein a fuel injection angle of the fuel injector is designed to satisfy both of a first condition in which the fuel is injected into the cavity of the piston and a second condition in which a fuel spray collision distance is longer than a breakup length, the fuel spray collision distance defined from a fuel injection position of the fuel injector to a position of the cavity of the piston with which the fuel collides, the breakup length defined from the fuel injection position of the fuel injector to a position where initial breakup of the fuel occurs.

2. The structure of claim 1, wherein the first condition is a condition in which when the fuel is injected by the fuel injector at an earliest timing on the compression stroke, the fuel is injected into the cavity of the piston.

3. The structure of claim 2, wherein when a radius of the cavity is “Rc,” a distance from a position of the upper surface of the piston to the fuel injector at the earliest timing of the fuel injection on the compression stroke is “Lp,” and the fuel injection angle of the fuel injector is “α,” the first condition is expressed by the following Equation 1:
Rc>Lp×tan α (1).

4. The structure of claim 1, wherein the second condition is a condition in which the fuel spray collision distance is longer than the breakup length when the fuel is injected by the fuel injector at a top dead center on the compression stroke.

5. The structure of claim 4, wherein when a depth of the cavity is “Dc,” a pressure of the fuel injected by the fuel injector is “Pf,” a pressure inside the combustion chamber is “Pa,” the fuel injection angle of the fuel injector is “α,” and a predetermined coefficient is “k,” the second condition is expressed by the following Equation 2:
Dc>k×Pa×cos α/{2(Pf−Pa)} (2).

6. A combustion chamber structure for an engine, the engine injecting fuel on a compression stroke within a predetermined engine operating range, the combustion chamber structure comprising:
a piston formed with a downward dented cavity at a central part of an upper surface thereof; and
a fuel injector provided above the piston and on an extended line of a central axis of the piston, the fuel injector changing an injection timing of the fuel on the compression stroke according to an operating state of the engine,
wherein a fuel injection angle of the fuel injector is designed to satisfy both of a first condition in which the fuel is injected into the cavity of the piston and a second condition in which a fuel spray collision distance is longer than a breakup length, the fuel spray collision distance defined from a fuel injection position of the fuel injector to a position of the cavity of the piston with which the fuel collides, the breakup length defined from the fuel injection position of the fuel injector to a position where an initial breakup of the fuel occurs,
wherein when a radius of the cavity is “Rc,” a distance from a position of the upper surface of the piston to the fuel injector at an earliest timing of the fuel injection on the compression stroke is “Lp,” and the fuel injection angle of the fuel injector is “α,” the first condition is expressed by the following Equation 1:
Rc>Lp×tan α (1), and
wherein when a depth of the cavity is “Dc,” a pressure of the fuel injected by the fuel injector is “Pf,” a pressure inside the combustion chamber is “Pa,” the fuel injection angle of the fuel injector is “α,” and a predetermined coefficient is “k,” the second condition is expressed by the following Equation 2:
Dc>k×Pa×cos α/{2(Pf−Pa)} (2).
